(19) United States
(12) Patent Application Publication
(10) Pub. No.: US 2026/0264944 A1
(43) Pub. Date: Sep. 10, 2026

(54) Stackable storage box with dual-latch locking structure

(71) Applicant: Gendi ZOU, Yueyang (CN)

(72) Inventor: Gendi ZOU, Yueyang (CN)

(21) Appl. No.: 19/658,505

(22) Filed: Apr. 25, 2026

(51) Int. Cl. B65D 43/02; B65D 21/02; E05B 65/52

(52) U.S. Cl. CPC B65D 43/02; B65D 21/0209; E05B 65/52; B65D 2543/00194

(57) ABSTRACT

A stackable storage box with a dual-latch locking structure includes at least two storage box bodies. Each of the storage box bodies includes a bottom plate, side plates, a lid, and a latch member disposed on an outer side of a top of the side plate. The latch member includes a first latch portion rotatably connected to the side plates and a second latch portion rotatably connected to the first latch portion. The two storage box bodies can be relatively freely stacked, the bottom plate of one of the storage box bodies is correspondingly stacked on the lid of the other storage box body. The first latch portion is operable to release or latch on the lid of the corresponding storage box body, while the second latch portion is operable to release or secure the bottom of an adjacent storage box body.

### TECHNICAL FIELD

The present disclosure relates to the technical field of item storage, and in particular to a stackable storage box with a dual-latch locking structure.

### BACKGROUND

With the improvement of living standards, the number of daily household items has been increasing, making efficient storage of items an essential need for modern families. Storage boxes serve as primary storage tools for this purpose.

Existing storage boxes usually only meet the storage needs of a single unit. When a plurality of storage boxes are stacked one above another, existing structures mostly rely on simple stacking or localized limiting features to achieve stacking. They lack a reliable interlocking relationship between the boxes, making them prone to relative displacement or even detachment during overall handling or movement. Furthermore, conventional latching structures are typically only used to secure a lid of a single storage box itself, and it is difficult for them to simultaneously keep the lid of the single storage box closed and connect to an upper storage box.

In existing solutions, even if some latch members are capable of contacting two separate portions simultaneously, they often lack a clear staged release mechanism. When a user separates an upper storage box, the lid of a lower storage box is easily unlocked simultaneously. As a result, the upper storage box cannot be released without affecting the closed state of the lid of the lower storage box, thereby adversely affecting user experience and storage safety. Therefore, it is necessary to provide an improved technical solution.

### SUMMARY

An objective of the present disclosure is to solve at least one of the defects existing in the prior art, and to provide a stackable storage box with a dual-latch locking structure. By means of the dual-latch locking structure, a single latch assembly can simultaneously achieve locking of a lid of a storage box and a bottom of an upper storage box, and enable the upper storage box to be released with priority while the lid of the corresponding storage box remains in a closed state.

To achieve the above objective, in a first aspect, an embodiment of the present disclosure provides the following technical solution: a stackable storage box with a dual-latch locking structure for household storage, including at least two storage box bodies; each of the storage box bodies includes: a bottom plate, side plates extending upward from a periphery of the bottom plate, a lid detachably fitted over a top of the side plates, and a latch member disposed on an outer side of the top of the side plates; and the latch member includes a first latch portion rotatably connected to the side plates and a second latch portion rotatably connected to the first latch portion;

specifically, the at least two storage box bodies are freely stackable, and the bottom plate of one of the storage box bodies is correspondingly stacked on the lid of the other storage box body; and the first latch portion is operably configured to release or latch on the lid of the corresponding storage box body, and the second latch portion is configured to be independently operable to release or latch on a bottom of the other adjacent storage box body.

Preferably, the first latch portion of each of the latch members includes a first rotating block, a first connecting piece, a second rotating block, and a first latch, where the first connecting piece extends upward from an outer side of a first rotating block, the second rotating block extends outward from an upper edge of the first connecting piece, and the first latch extends inward from the first connecting piece and is in latchable engagement with the corresponding lid; and

the second latch portion of each of the latch members includes a third rotating block rotatably connected to the second rotating block, a second connecting piece, and a second latch, where the third rotating block is rotatably connected to the second rotating block, the second connecting piece extends upward from an inner side of the third rotating block, and the second latch extends inward from the second connecting piece and is in latchable engagement with the bottom of the other adjacent storage box body.

The first latch portion and the second latch portion form a staged movement path through rotatable connection, such that the second latch portion does not drive the first latch portion to move when releasing the upper storage box body, thereby enabling priority release of the upper storage box body.

Preferably, an outer edge of the lid is provided with a first latch strip in latchable engagement with the latch member.

Preferably, the bottom of the storage box body is provided with a second latch strip in latchable engagement with the latch member.

Preferably, each of the storage box bodies is substantially in an overall shape of a cube, and the side plates include a pair of first side plates and a pair of second side plates; and the bottom plate, the first side plates, and the second side plates of each of the storage box bodies are detachably assembled together in a slot-connection manner.

Preferably, each of the storage box bodies is substantially in the overall shape of a rectangular parallelepiped, and the side plates include a pair of first side plates in a length direction and a pair of second side plates in a width direction.

Preferably, the first side plates are provided with a lateral opening-and-closing structure.

Preferably, the second side plates are provided with a downward opening-and-closing structure.

Preferably, a number of the latch members of each of the storage box bodies is two, and the two latch members are respectively arranged on the pair of the second side plates.

Preferably, each of the storage box bodies also includes casters disposed on an underside of the bottom plate.

Preferably, the casters are fixed casters.

Preferably, the casters are swivel casters.

Preferably, each of the storage box bodies is configured as a transparent structure, and is made from at least one of acrylic, polypropylene, acrylonitrile-butadiene-styrene polymer, and polyethylene terephthalate.

The present disclosure at least has the following beneficial effects:

The stackable storage box with a dual-latch locking structure provided in the embodiments of the present disclosure includes at least two storage box bodies, which can be relatively freely stacked and combined; each of the storage box bodies defines an independent storage space that is closed or opened by a corresponding lid; an upper portion of each side plate of each of the storage box bodies is provided with a latch member, and the latch member includes a first latch portion capable of engaging with the lid and a second latch portion capable of engaging with a bottom of an adjacent storage box body stacked above. Accordingly, the latch member simultaneously achieves the locking of the storage box body itself and a connection between the storage box body and the upper storage box body. Through a single latch member, dual locking of the lid of the storage box body and the bottom of the upper storage box body is simultaneously realized, achieving a high degree of structural integration. After a plurality of storage boxes are stacked, they no longer rely solely on gravity for stacking, but instead form a reliable connection, thereby improving overall stability. In the embodiments, the second latch portion does not drive the first latch portion to move when releasing the upper storage box body, thereby enabling priority release of the upper storage box body. The lid of the storage box body remains in a closed state, thereby achieving staged release and avoiding accidental opening. The structure is applicable both to independent use of a single storage box body and to stable combined use of the plurality of storage box bodies.

### BRIEF DESCRIPTION OF THE DRAWINGS

FIG. 1 is a schematic diagram of a three-dimensional structure of a stackable storage box with a dual-latch locking structure according to an embodiment of the present disclosure.

FIG. 2 is a front view of the stackable storage box in FIG. 1.

FIG. 3 is a front view of the stackable storage box in FIG. 2 in a separated state.

FIG. 4 is a schematic diagram of a three-dimensional structure of a latch member of the stackable storage box in FIG. 1.

FIG. 5 is a side view of the latch member in FIG. 4.

FIG. 6 is a side view of the latch member in FIG. 4 in another state.

Reference numerals in the accompanying drawings:
10. storage box body; 11. bottom plate; 12. side plate; 121. first side plate; 122. second side plate; 13. lid; 131. first latch strip; 14. latch member; 141. first latch portion; 142. second latch portion; 143. first rotating block; 144. first connecting piece; 145. second rotating block; 146. first latch; 147. second connecting piece; 148. second latch; 15. second latch strip; and 16. caster.

### DETAILED DESCRIPTIONS OF THE EMBODIMENTS

The technical solutions in the embodiments of the present disclosure are described below clearly and comprehensively in conjunction with the accompanying drawings in the embodiments of the present disclosure. It is obvious that the embodiments described are merely a part of, not all of, embodiments of the present disclosure. All other embodiments obtained by those of ordinary skill in the art based on the embodiments of the present disclosure without making creative efforts fall within the scope of protection of the present disclosure.

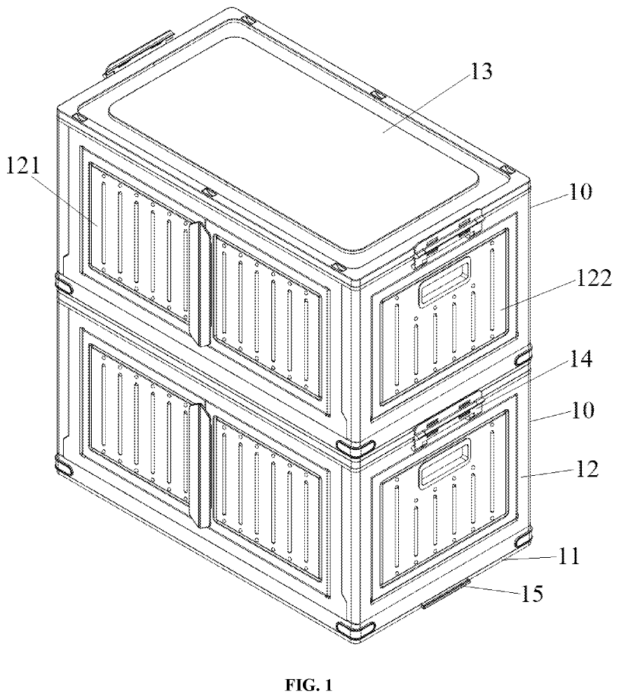

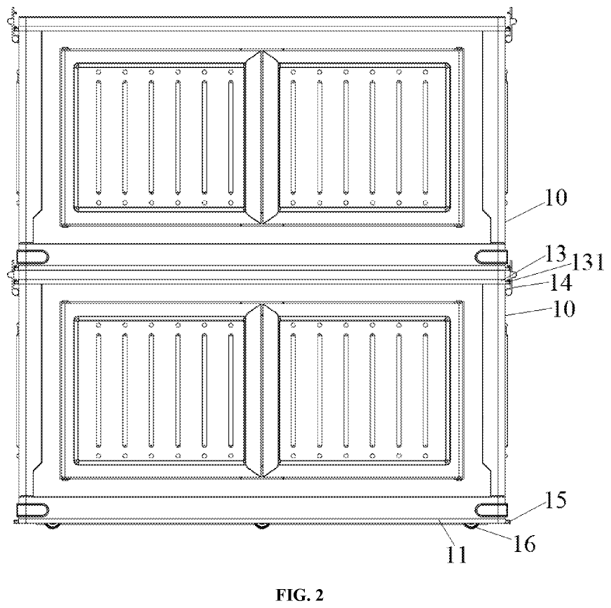

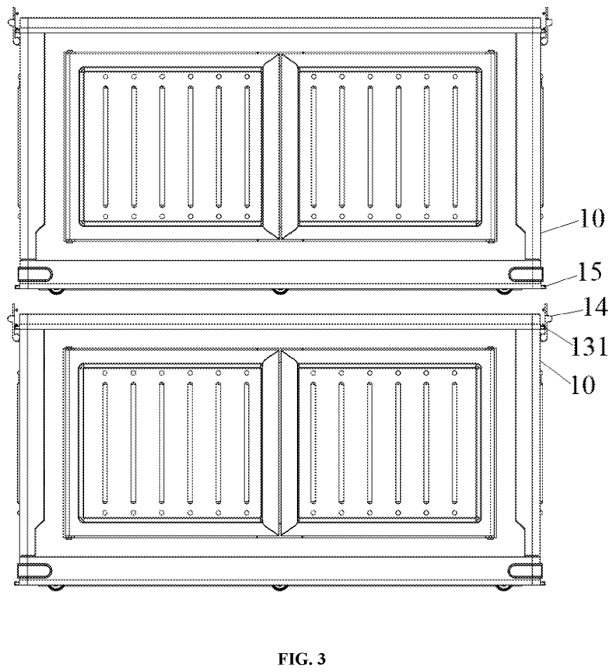

Referring to FIGS. 1-3, an embodiment of the present disclosure provides a stackable storage box with a dual-latch locking structure for household storage. The stackable storage box can be used independently or in combination according to storage needs. In a combined state, a plurality of storage box bodies can be interlocked to form a stable structure.

The stackable storage box includes at least two storage box bodies 10. Each of the storage box bodies 10 includes: a bottom plate 11, side plates 12 extending upward from a periphery of the bottom plate 11, a lid 13 detachably fitted over a top of each side plate 12, and a latch member 14 disposed on an outer side of the top of each side plate 12; and specifically, the at least two storage box bodies 10 are freely stackable, and the bottom plate 11 of one of the storage box bodies 10 is correspondingly stacked on the lid 13 of the other storage box body 10. Each of the latch members 14 is operably configured to release or latch on the lid 13 of the corresponding storage box body 10 and a bottom of the other adjacent storage box body 10.

Taking a combination of two storage box bodies 10 as an example, the two storage box bodies 10 are stacked, and the latch member 14 of a lower storage box body 10 is capable of latching on the lid 13 of the lower storage box body 10 and a bottom of an upper storage box body 10, while the latch member 14 of the upper storage box body 10 only latches on the lid 13 of the upper storage box body 10. Taking a combination of three storage box bodies 10 as an example, the three storage box bodies 10 are stacked sequentially. The latch member 14 of a bottommost storage box body 10 is capable of latching on the lid 13 of the bottommost storage box body 10 and a bottom of a middle storage box body 10; the latch member 14 of the middle storage box body 10 is capable of latching on the lid 13 of the middle storage box body 10 and a bottom of a topmost storage box body 10; and the latch member 14 of the topmost storage box body 10 only latches on the lid 13 of the topmost storage box body 10.

A plurality of the storage box bodies 10 form a stable combined connection, rather than a conventional placement relationship, and can be used as a stable combined structure for extended applications, such as being transported or moved as a single unit.

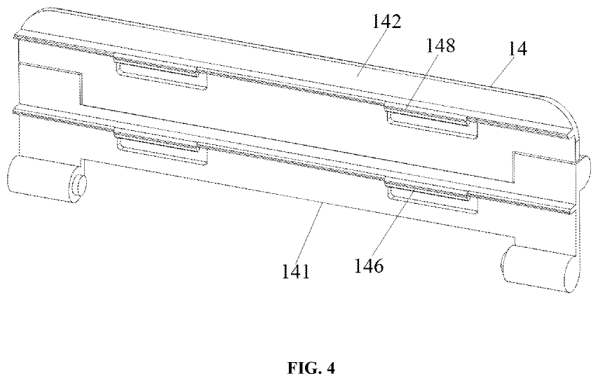

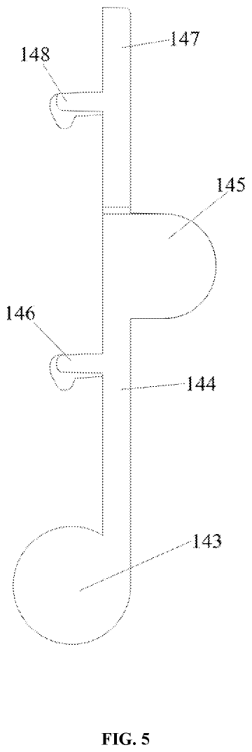

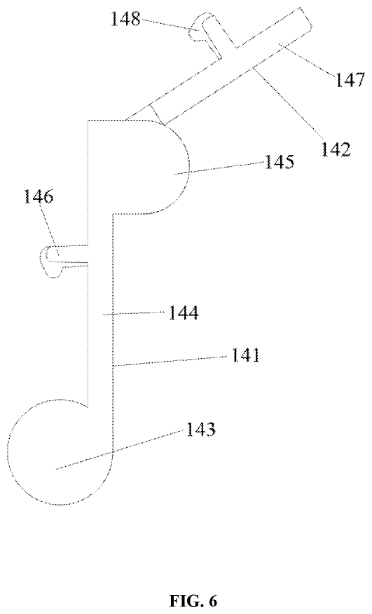

Referring to FIGS. 4-6, further, each of the latch members 14 is rotatably connected to a corresponding side plate 12. Each of the latch members 14 includes a first latch portion 141 in latchable engagement with the corresponding lid 13 and a second latch portion 142 in latchable engagement with the bottom of the other adjacent storage box body 10.

Correspondingly, the side plate 12 is provided with a connecting block (not shown in the figures) corresponding to a first rotating block 143, and the first rotating block 143 is rotatably connected to the connecting block, so as to realize a rotatable connection between the latch member 14 and the side plates 12.

In this embodiment, the latch member 14 is further provided with two latch portions, which are in latchable engagement with the lid 13 and the bottom of the upper storage box body 10, thereby forming a combined latching structure. Specifically, the first latch portion 141 is rotatably connected to the side plates 12, such that it can move toward and away from the storage box body 10, thereby realizing latching on and releasing from the corresponding lid 13 and the bottom of the upper storage box body 10.

It should be understood that a number of the latch members 14 may be set as needed, and may be two arranged in pairs, or spaced apart in sets of three or four. Out of consideration for a simplified structural design, two of the latch members arranged in pairs are a preferred embodiment.

Further, the first latch portion 141 is rotatably connected to the corresponding side plate 12, and the second latch portion 142 is rotatably connected to the first latch portion 141. In this embodiment, the first latch portion 141 and the second latch portion 142 are rotatably connected to each other, such that a latching stroke of the second latch portion 142 is decoupled from a latching stroke of the first latch portion 141. In other words, the latch member 14 independently releases the bottom of the upper storage box body 10 by releasing the second latch portion 142, thereby realizing a staged movement path of the first latch portion 141 and the second latch portion 142. Operation of the second latch portion 142 does not drive the first latch portion 141 to undergo synchronous movement, such that the lid 13 of the corresponding storage box body 10 is not released synchronously. This feature is primarily applied to separation of the storage box bodies 10 to prevent the storage box bodies 10 from opening in a linked manner.

Further, the first latch portion 141 of each of the latch members 14 includes a first rotating block 143, a first connecting piece 144 extending upward from an outer side of the first rotating block 143, a second rotating block 145 extending outward from an upper edge of the first connecting piece 144, and a first latch 146 extending inward from the first connecting piece 144. The first latch 146 is in latchable engagement with the corresponding lid 13; and

the second latch portion 142 of each of the latch members 14 includes a third rotating block (not shown in the figures) rotatably connected to the second rotating block 145, a second connecting piece 147 extending upward from an inner side of the third rotating block, and a second latch 148 extending inward from the second connecting piece 147. The second latch 148 is in latchable engagement with the bottom of the other adjacent storage box body 10.

In another alternative embodiment, connection with the lid 13 and the bottom of the upper storage box body 10 is realized through specific rotating structures and latch structures, respectively. It should be understood that the structures are not limited to the above embodiments, as long as latching connection between the lid 13 and the bottom of the upper storage box body 10 can be achieved.

Further, each of the latch members 14 includes a first rotating block 143 rotatably connected to the corresponding side plate, a connecting piece (not shown in the figures) extending upward from an outer side of the first rotating block 143, and a first latch 146 and a second latch 148 extending inward from the connecting piece at intervals. The first latch 146 is in latchable engagement with the corresponding lid 13, and the second latch 148 is in latchable engagement with the bottom of the other adjacent storage box body 10. In this embodiment, the latch member 14 is a dual-stage locking structure, which simultaneously realizes connection with the lid 13 and the bottom of the upper storage box body 10. When separating the plurality of storage box bodies 10, the latch member 14 is first correspondingly rotated to release the upper storage box body, and then the latch member 14 is rotated to latch on only the lid 13 of the corresponding storage box body 10.

Further, an outer edge of the lid 13 is provided with a first latch strip 131 in latchable engagement with the latch member 14. In this embodiment, the latch engagement is specifically realized by providing the first latch strip 131 and the latch member 14. It should be understood that the latch structure is not limited to the above structure, and may also be a corresponding hook engagement structure, a magnetic engagement structure, or the like.

Further, the bottom of the storage box body 10 is provided with a second latch strip 15 in latchable engagement with the latch member 14. In this embodiment, a structure of the second latch strip 15 is similar to that of the first latch strip 131, and correspondingly, the structure thereof is not limited to the above structure. Specifically, the second latch strip 15 is correspondingly arranged on an outer edge of the bottom plate 11.

Further, each of the storage box bodies 10 is substantially in an overall shape of a cube, and the side plates 12 include a pair of first side plates 121 and a pair of second side plates 122. The bottom plate 11, the first side plates 121, and the second side plates 122 of each of the storage box bodies 10 are detachably assembled together in a slot-connection manner. In this embodiment, the storage box body 10 adopts an overall modular structure, facilitating assembly and disassembly. When it is unnecessary to store the items, the empty storage box body 10 can be directly disassembled and stored in a plate-shaped structure, thereby optimizing household space utilization.

Further, each of the storage box bodies 10 is substantially in the overall shape of a rectangular parallelepiped, and the side plates 12 include a pair of first side plates 121 in a length direction and a pair of second side plates 122 in a width direction.

Specifically, the first side plates 121 are provided with a lateral opening-and-closing structure. The lateral opening-and-closing structure is arranged in the length direction, thereby further improving convenience of storing and retrieving items. Specifically, each of the first side plates 121 includes a frame body and two opening-and-closing door bodies arranged in the frame body. Two opposite sides of the two door bodies are pivotally connected to the frame body, respectively, such that an opening-and-closing structure is formed between them. A handle is disposed on the frame body to facilitate an opening and closing operation.

Specifically, the second side plates 122 are provided with a downward opening-and-closing structure. The downward opening-and-closing structure is arranged on a side portion, thereby further improving convenience of accessing and retrieving items. Specifically, each of the second side plates 122 includes a frame body and a downward door body arranged in the frame body. A lower side of the downward door body is pivotally connected to the frame body to form the downward opening-and-closing structure, and a recessed handle structure is provided on an upper portion of the downward door body to facilitate the opening and closing operation.

In a preferred embodiment, the number of the latch members 14 of each of the storage box bodies 10 is two, and the two latch members 14 are respectively arranged on the pair of the second side plates 122. However, the number of the latch members 14 is not limited to two, and the positions thereof are not limited to the second side plates 122 on the side portions.

It should be understood that the overall shape of the storage box body 10 is not limited to a rectangular parallelepiped, and may also be a cube, a cylinder, a pentagonal prism, a hexagonal prism, and the like, as long as it generally needs to be configured as a prismatic structure to enable stable vertical stacking.

Further, each of the storage box bodies 10 also includes casters 16 disposed on an underside of the bottom plate 11. It should be understood that the rollers may be fixed casters or swivel casters. In addition, the casters 16 may be configured to be detachably connected to the bottom plate 11 to facilitate disassembly and storage of the storage box body 10, and further optimize the storage space.

Further, each of the storage box bodies 10 is configured as a transparent structure, to facilitate convenient observation of a storage condition inside each of the storage box bodies 10. Specifically, a material of the storage box body 10 is selected from at least one of acrylic, polypropylene, acrylonitrile-butadiene-styrene polymer, and polyethylene terephthalate.

The stackable storage box provided in the present disclosure includes at least two storage box bodies 10, which can be relatively freely stacked and combined. Each of the storage box bodies 10 defines an independent storage space that is closed or opened by a corresponding lid 13. An upper portion of each side plate 12 of each of the storage box bodies 10 is provided with a latch member 14, and the latch member 14 can simultaneously latch on the lid 13 and a bottom of the other storage box body 10 stacked directly above. Accordingly, the latch member 14 simultaneously realizes latching of the corresponding storage box body 10 and connection between the corresponding storage box body 10 and the upper storage box body 10, thereby forming both a stable independent storage structure and a stable combined configuration, and meeting the requirements of combined storage functions.

Finally, it should be noted that the above descriptions are merely preferred embodiments of the present disclosure and are not intended to limit the present disclosure. Although the present disclosure has been described in detail with reference to the above embodiment, for those skilled in the art, it is still apparent that the technical solutions described in the above embodiment may be modified, or some technical features thereof may be equivalently replaced. Any modifications, equivalent replacements, improvements, etc. made within the spirit and principles of the present disclosure shall fall within the protection scope of the present disclosure.

What is claimed is:

1. A stackable storage box with a dual-latch locking structure, comprising at least two storage box bodies; each of the storage box bodies comprises: a bottom plate, side plates extending upward from a periphery of the bottom plate, a lid detachably fitted over a top of the side plates, and a latch member disposed on an outer side of the top of the side plates; and the latch member comprises a first latch portion rotatably connected to the side plates and a second latch portion rotatably connected to the first latch portion; wherein
the at least two storage box bodies are configured to be freely stackable; the bottom plate of one of the storage box bodies is stacked on the lid of the other storage box body; and the first latch portion is configured to operably release or latch on the lid of the corresponding storage box body, and the second latch portion is configured to be independently operable to release or latch on a bottom of the other adjacent storage box body.

2. The stackable storage box with a dual-latch locking structure according to claim 1, wherein the first latch portion of each of the latch members comprises a first rotating block, a first connecting piece, a second rotating block, and a first latch; the first connecting piece extends upward from an outer side of the first rotating block, the second rotating block extends outward from an upper edge of the first connecting piece, and the first latch extends inward from the first connecting piece and is in latchable engagement with the corresponding lid; and
the second latch portion of each of the latch members comprises a third rotating block, a second connecting piece, and a second latch, wherein the third rotating block is rotatably connected to the second rotating block, the second connecting piece extends upward from an inner side of the third rotating block, and the second latch extends inward from the second connecting piece and is in latchable engagement with the bottom of the other adjacent storage box body.

3. The stackable storage box with a dual-latch locking structure according to claim 1, wherein an outer edge of the lid is provided with a first latch strip in latchable engagement with the latch member.

4. The stackable storage box with a dual-latch locking structure according to claim 1, wherein the bottom of the storage box body is provided with a second latch strip in latchable engagement with the latch member.

5. The stackable storage box with a dual-latch locking structure according to claim 1, wherein each of the storage box bodies is substantially in an overall shape of a cube, and the side plates comprise a pair of first side plates and a pair of second side plates; and the bottom plate, the first side plates, and the second side plates of each of the storage box bodies are detachably assembled together in a slot-connection manner.

6. The stackable storage box with a dual-latch locking structure according to claim 1, wherein each of the storage box bodies is substantially in the overall shape of a rectangular parallelepiped, and the side plates comprise a pair of first side plates in a length direction and a pair of second side plates in a width direction.

7. The stackable storage box with a dual-latch locking structure according to claim 6, wherein the first side plates are provided with a lateral opening-and-closing structure.

8. The stackable storage box with a dual-latch locking structure according to claim 6, wherein the second side plates are provided with a downward opening-and-closing structure.

9. The stackable storage box with a dual-latch locking structure according to claim 6, wherein a number of the latch members of each of the storage box bodies is two, and the two latch members are respectively arranged on the pair of the second side plates.

10. The stackable storage box with a dual-latch locking structure according to claim 1, wherein each of the storage box bodies further comprises casters disposed on an underside of the bottom plate.

11. The stackable storage box with a dual-latch locking structure according to claim 10, wherein the casters are fixed casters.

12. The stackable storage box with a dual-latch locking structure according to claim 10, wherein the casters are swivel casters.

13. The stackable storage box with a dual-latch locking structure according to claim 1, wherein each of the storage box bodies is configured as a transparent structure, and is made from at least one of acrylic, polypropylene, acrylonitrile-butadiene-styrene polymer, and polyethylene terephthalate.
